(19) United States
(12) Patent Application Publication
(10) Pub. No.: US 2006/0148485 A1
(43) Pub. Date: Jul. 6, 2006

(54) Method and a network element for providing a handover in a communications system

(76) Inventors: Arto Kangas, Espoo (FI); Uwe Schwarz, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/071,046

(22) Filed: Mar. 3, 2005

(30) Foreign Application Priority Data
Dec. 31, 2004 (FI) 20045515

(51) Int. Cl. H04Q 7/20; H04B 7/00

(52) U.S. Cl. 455/453; 455/450

(57) ABSTRACT

The invention relates to a method for providing a group communication handover in a communications system supporting group communication. In the invention communications terminals are detected that belong to a communications group; a load of the communications group is monitored in a first resource; and if the load exceeds a preset load level in the first resource, to at least one of the communications terminals of the group the group communication handover is performed from the first resource to a second resource.

### FIELD OF THE INVENTION

The present invention relates to communications systems, and more particularly to a handover in communications systems.

### BACKGROUND OF THE INVENTION

Group communication is communication, which can be simultaneously established to a group of radio users. In unicast communication, in which one data stream is sent separately to all members of the group using the same resources, e.g. to users that are in the same cell, problems may arise. These are due to the fact that group communication, e.g. group calls, create sudden traffic bursts in the downlink direction, i.e. towards receiving terminals. In the case of congestion, the last incoming call will be blocked, because on the downlink not enough capacity exists for sending the group call to every group member. This situation is definitely not desirable.

Prior art documents strive to minimize the number of cells assigned to mobile terminals involved in any given group call session. In this way, a situation can be avoided where resources are used from more than one base station, when mobile stations are receiving the same transmission. This is described e.g. in U.S. Pat. No. 6,725,052 titled A Cell Assignment Method During Group Calls where multiple mobile terminals are able to share a single downlink traffic channel within a given cell.

### BRIEF DISCLOSURE OF THE INVENTION

An object of the present invention is thus to provide a method and an apparatus for implementing the method so as to overcome the above problem. The objects of the invention are achieved by a method and an arrangement which are characterized by what is stated in the independent claims. Preferred embodiments of the invention are disclosed in the dependent claims.

The invention is based on realizing the problem and solving it by using at least two different resources, a first resource and a second resource.

An advantageous feature of the method and arrangement of the invention is that resources can be used more efficiently.

### BRIEF DESCRIPTION OF THE DRAWINGS

In the following, the invention will be described in greater detail by means of preferred embodiments with reference to the accompanying drawings, in which

FIG. 1 is a general system chart illustrating a communications system with the principles of the present invention;

FIG. 2 is a traffic diagram of a communication group including traffic from group calls;

FIG. 3 shows traffic diagrams of two different cells;

FIG. 4 shows traffic diagrams of two different cells with group call aware handovers; and

FIG. 5 shows elements of the communications system according to one embodiment of the present invention.

### DETAILED DESCRIPTION OF THE INVENTION

Although the preferred embodiments of the invention will be described in connection with GSM (Global System for Mobile communications) and GPRS (General Packet Radio System) systems, the basic principles of the invention and its embodiments can be employed in any packet mode communications system, such as a UMTS (Universal Mobile Telecommunications System) system or in a WLAN (Wireless Local Area Network) system, and for any data—voice, data, short message, video, image, music etc. The communications system, in which the invention and its embodiments can be employed, can thus be one of the following: a 2 G network, a 2.5 G network, a 3 G network, a 4 G network or a network of a mixture thereof.

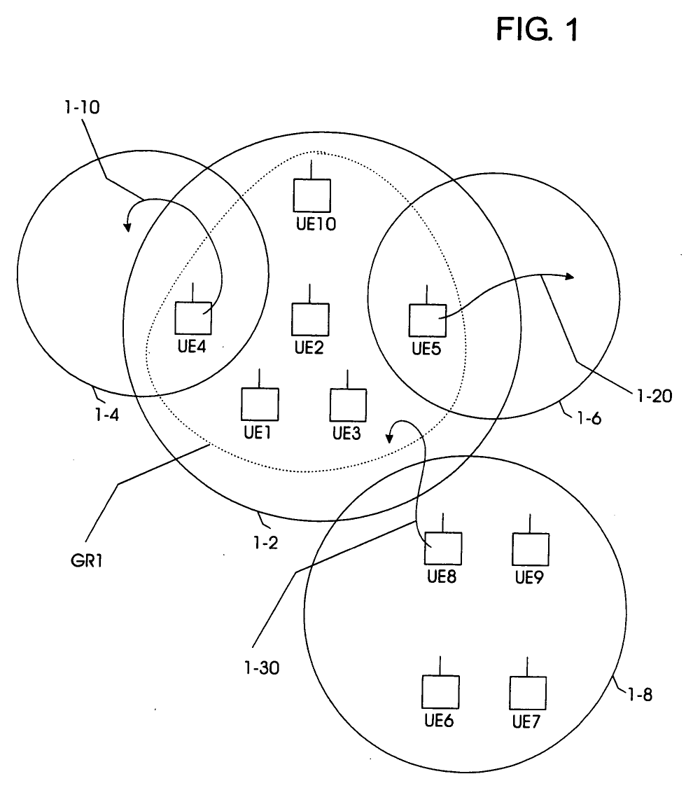

FIG. 1 is a general system chart illustrating a communications system with the principles of the present invention. Five mobile subscribers UE1 to UE5 (UE, User Equipment), all belonging to the same communication group GR1 are connected to the communications system and are located in the area of a cell 1, 1-2. User equipment UE10, which has joined the group GR1 last, is also located in the cell 1. Four mobile subscribers UE6 to UE9 are connected to the same or another communications system and are located in the area of a cell 2, 1-8.

The communication terminals UE1 to UE10 are equipped with a group communication application and they may be e.g. conventional user equipment or 3^{rd} generation, such as UMTS, user equipment.

In unicast communication, one data stream is sent separately to all members of a group using the same resources. This can lead to a situation where the capacity of the resource used by the communication group is exceeded, e.g. because no radio frequency or capacity is available any longer, e.g. no memory of a DSP (Digital Signal Processor) element in a BSC (Base Station Controller) element or in a BTS (Base Transceiver Station) element is available. When it is detected that a new independent resource(s) is (are) needed, for at least one member of the communication group a new resource(s) can be allocated and provided. For example, the user equipment UE4 can be handed over 1-10 to a third cell 1-4 and/or the user equipment UE5 can be handed over 1-20 to a fourth cell 1-6, although they were not the ones that arrived at the group last.

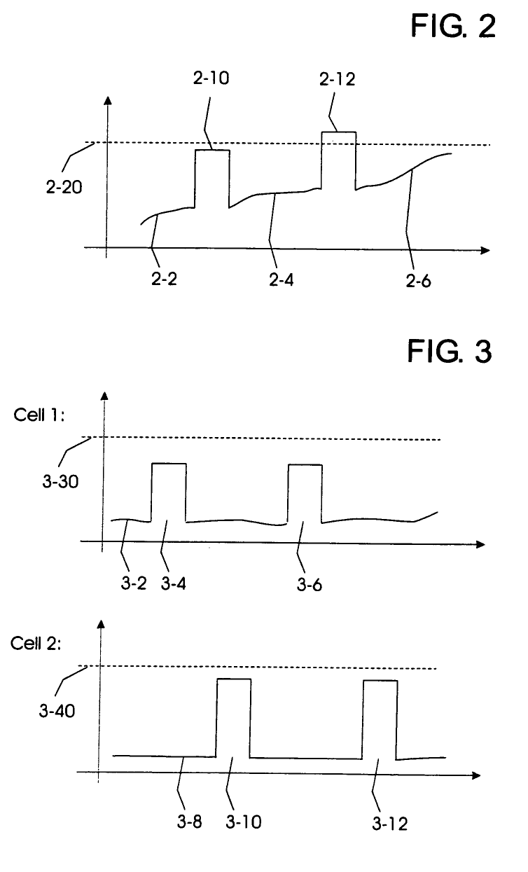

FIG. 2 is a diagram showing the load within one resource caused by group communication 2-10, 2-12 and by other traffic, 2-2, 2-4, 2-6. The load can be e.g. bits per second in a function of time. A threshold level of a group communication load is shown as line 2-20.

As can be seen, the group communication, e.g. the group calls, creates sudden traffic bursts, which causes the level of traffic to rise. At the first burst 2-10 the threshold level is almost reached, and at the second burst 2-12 the threshold level is even exceeded. This causes problems when the group communication members are using the same resources, e.g. are located in the same cell.

The threshold level can be set, determined based e.g. on the sum of the group communication burst and other traffic within a given period or the group communication burst. An operator can set the level.

FIG. 3 shows traffic diagrams of two different cells 1-2 and 1-8 (FIG. 1). 3-2 and 3-8 are the loads from traffic other than from the group communication and 3-4, 3-6 and 3-10, 3-12 show traffic bursts from the group calls in the cells 1-2 and 1-8, respectively. 3-30 and 3-40 are the threshold levels of the respective cells. Since time axes of the loads of the cell 1 and the cell 2 match, it can be seen that the traffic bursts from the cell 2 occur later than those in the cell 1. Since different cells represent one possible different resource, the cell 2 can take some of the traffic from the cell 1 and vice versa, so that the capacities in different cells can be used for alleviating the resource problem. This situation occurs e.g. when the loads 3-4, 3-6, 3-10, 3-12 are almost at the threshold level.

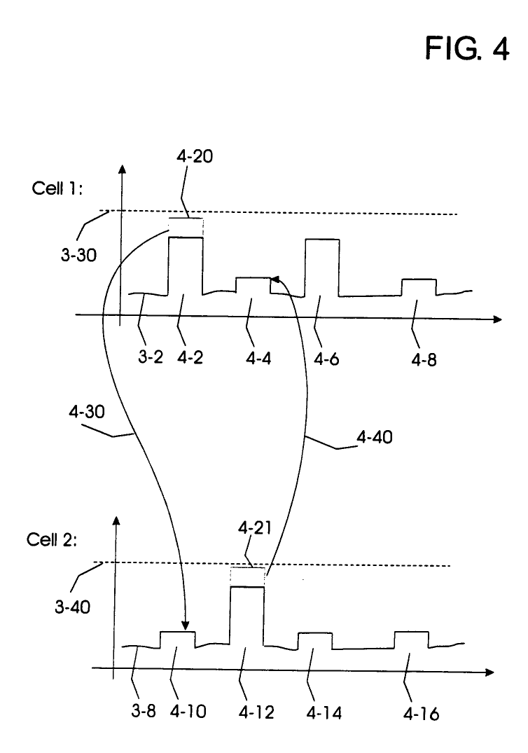

FIG. 4 shows traffic diagrams of two different cells of FIG. 3 with group communication aware handovers. The members of the communication group, and hence their traffic, can be distributed e.g. by handovers to independent resource units. Thus e.g. the high load 3-4 (FIG. 3) caused by the members of the group communication in the cell 1 can be divided between the load 4-2 in the cell 1 and the load 4-10 in the cell 2. In other words, the part 4-20 of the burst 3-4 in the cell 1 is resourced to the cell 2. Correspondingly, the load 3-10 (FIG. 3) in the cell 2 can be divided between the load 4-12 in the cell 2 and the load 4-4 in the cell 1 (the part 4-21 of the burst 3-10 in the cell 2 is resourced to the cell 1), the load 3-6 (FIG. 3) in the cell 1 can be divided between the load 4-6 in the cell 1 and the load 4-14 in the cell 2, and the load 3-12 (FIG. 3) in the cell 2 can be divided between the load 4-16 in the cell 2 and the load 4-8 in the cell 1.

In other words, the group members can be distributed e.g. via the handovers over the independent network resources where it is possible to increase the group call capacity, especially in multi-layer, multi-system networks, where e.g. an umbrella cell covering one or several small and micro cells and the areas there between are used. The members can be resourced to another resource before, during or after the group communication.

It is also possible that other communications terminals enter these resources although not being members of the communications group.

The method for managing group communication may comprise different phases. One possible method can be implemented by detecting, identifying communications terminals that belong to the same communications group, e.g. in an element comprising an AC block (Admission Control) by monitoring load of the communications group in a first resource, and if the load exceeds a preset load level in the first resource, by performing a handover on at least one of the communications terminals of the group from a first resource to a second resource.

Before performing the group communication handover of the communications terminal from a first resource to a second resource it is also possible to check, whether the second resource has capacity to serve the communications terminal(s), from a first resource or from some other resource, whether a neighbour cell is good enough to receive one or more terminals. There may also be a wait-timer in the second resource, a cell to be used so that after the handover rapid transmissions of terminals, also called a ping-pong effect, between different resources can be avoided.

In still another embodiments of the invention, the handover can be managed at least partly based on a calculation of the number of group members in different resources. The calculation and management may take place in addition to monitoring the load of the communications group in a first resource and acting according to the load or without the monitoring phase. In the latter case, a target cell or another resource for group members can be checked and members of the group or groups can be distributed over different cells already before an overload, if there is e.g. a certain number of group members in the same cell. An inter-system handover can also be implemented.

In a 3 G network, the group call handover can be implemented with 3 GPP support so that a group ID can be obtained from a core network, such as a PoC server, and the handover can be managed at least partly based on said group ID.

Traffic can be distributed by providing the threshold level 3-30, 3-40 of the group communication load, detecting the group communication load 3-4, 3-6, 3-10, 3-12 and, if the group communication load exceeds the threshold level, providing at least one member of the group with a new, second resource, which is independent of the original, first resource. It is also possible that one member of the communications group is handed over from the first resource to another resource, and another member is handed over from the first resource to still another resource.

The user equipment UE10 (FIG. 1) may be the last group GR1 member receiving the group communication and thus the member whose traffic, when added to the traffic of other members of the same group causes the load to exceed the threshold level. However, new resources for UE10 or to some other member of the same group can be allocated and provided no matter of the order of joining the group and/or receiving the group communication. The first member UE1 or the last member UE10 or some other member UE2 to UE5 there between may, for example, be the one to whom new independent resources are allocated and provided.

In other words, the purpose of the invention and its embodiments is to handle group calls as such and try, as much as possible, to avoid concentration of members of the same group to single network resources. The single network resource may be e.g. a cell, the sub-area to which a set of radio resources not usable in adjacent sub-areas is allocated, a PCU element (Packet Control Unit), a BSC element, a SGSN element (Serving GPRS Support Node), or a radio access technology used for connecting different terminals and applications to communication networks by using radio frequency signals, e.g. TDMA and WCDMA technologies.

If cells are used as resources, a mobile station, which has the best neighbour cell may be handed over, not the one which has arrived last. In alternative embodiments, a mobile station, which has arrived at a certain moment or which has the second or third best connection to its neighbour cell(s) may be handed over. Alternatively, user equipment is provided with priorities, and delivery of new resources is at least partly based on these priorities. Billing information may also be used for allocating and/or providing new resource(s). Also the order in which the communications terminals have entered the resource can be taken into account. Different combinations of these embodiments are also possible.

In addition, the number of members in a target cell, i.e. the number of members in a new resource, may be checked before handover to avoid adding a member to an already existing large cell, e.g. 1-8 (FIG. 1). This requires that the number of group members located in the neighbour cells is known. These embodiments will be described later. It is important to specifically consider a fractional load of the same communications group in the second resource, because the members of the same group receive data at the same time, i.e. use capacity at the same time.

The invention and its embodiments can be implemented in a network element that provides a handover in a communications system supporting group communication. The element can comprises an admission control block for detecting communications terminals (UE1 . . . UE5) that belong to a communications group (GR1), for monitoring a group communication load (4-2 . . . 4-16) and for indicating a need for handover (1-10, 1-20) for at least one communications terminal (UE1 . . . UE5) of the group (GR1) from a first resource (1-2) to a second resource (1-4, 1-6) in response to the group communication load (4-2 . . . 4-16) exceeding a predetermined threshold level (3-30, 3-40) set for the group communication load (4-2 . . . 4-16).

The element can be configured to determine the actual allocation of resources in response to a request for a new resource (1-4, 1-6) during a bearer setup and/or during a bearer re-negotiation and/or during a handover (1-10, 1-20). Furthermore, the determination is at least partly based on available resources (1-4, 1-6) and/or the state of currently allocated resources (1-4, 1-6) and/or the system load and/or capabilities of a communications terminal (UE1 . . . UE5). The network element can be e.g. a radio access network element, a Radio Network Controller RNC or Base Station Controller, BSC.

The Admission Control (AC) block can be described to be a block, which detects the consistently simultaneous arrival of calls and allocates independent resources to them. The AC deals with the management of available resources in the cell. Whenever a request is made for resources during a bearer setup, a bearer re-negotiation or a handover, a decision process may determine the actual allocation carried out. The decision can be based on the available resources and/or the state of the currently allocated resources and/or the system load and/or UE capabilities.

Another possible element for implementing the invention and its embodiments is an element which comprises a handover control block having memory for at least one parameter relating to group communication load (4-2 . . . 4-16), the handover control block being configured, at least partly based on said parameter, to perform the handover (1-10, 1-20) for at least one recipient (UE1 . . . UE5) of the group (GR1) from a first resource (1-2) to a second resource (1-4, 1-6) in response to a group communication load (4-2 . . . 4-16) exceeding a predetermined threshold level (3-30, 3-40) set for the group communication load (4-2 . . . 4-16).

Handover Control (HOC) element can be an object e.g. in a BSDATA in a GPRS connection that contains a parameter(s) for controlling handover procedures in a base station system (BSS) radio network. In the Handover Control, the members of the same group can be handed over to a separate network resource (system, frequency, cell, PCU, etc.) to distribute traffic bursts over multiple entities.

The Admission Control (AC) block, element and the Handover Control (HOC) block, element possibly locating in an RNC element or in a BSC element may participate in communication when the AC has first detected traffic of calls and then the HOC has handed over some load to another resource.

Resources can be divided e.g. before receiving the group communication, just after receiving the group communication or only after detecting that, taken as a whole, the allocation of the resources is not optimal or not within certain limits.

In addition to group calls, such as online gaming and conference calling, the invention and its embodiments are well suitable for PoC (push-to-talk over cellular) one-to-many services, i.e. services where one data stream may be sent to many recipients at the same time. A push-to-talk over cellular is a service of GPRS mobile stations which enables real-time one-to-one and one-to-many (group) voice communication in a cellular network. It can be e.g. a voice over IP (Internet Protocol) VoIP application running over 2 G GPRS and 2.5 G EGPRS (enhanced GPRS) networks. PoC users concentrated in one GPRS cell can be handed over e.g. to other GPRS cells or to a WCDMA system. It is also possible that PoC users concentrated in one cell in WCDMA system are handed over to another WCDMA cell or to a GPRS cell.

These solutions are technically viable if RAN, a third generation network that provides mobile access to a number of core networks of both mobile and fixed origin, knows the group members.

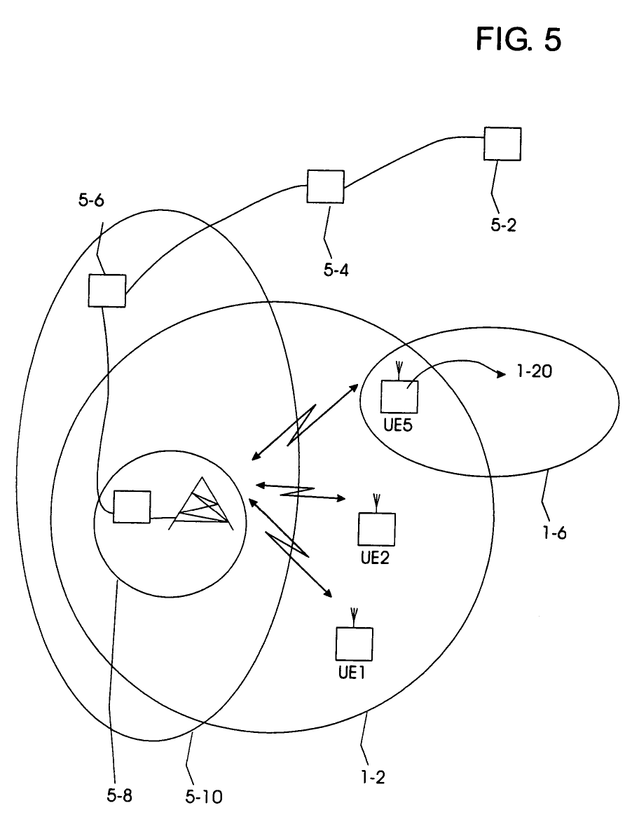

FIG. 5 shows elements of the communications system of one embodiment of the present invention. Two cells 1-2, 1-6 are shown as well as three mobile terminals UE1, UE2 and UE5 belonging to the communication group GR1 (FIG. 1) of the cell 1-2.

In FIG. 5, a group call server element 5-2 knows the communication group. Information indicating which element belongs to the group is obtained from the uplink communication. 5-4 is an MSC (Mobile Services Switching Centre) element performing the switching functions in its area of operation and controlling the interworking with other networks. In the GPRS, the network 5-4 represents an SGSN element, which is a GPRS support node that serves a GPRS mobile station by sending or receiving packets via a base station subsystem or a radio access network 5-10.

Reference numeral 5-6 describes a radio network controller RNC element which performs tasks similar to those performed by a base station controller BSC in the GSM system. The element is in charge of controlling the use and integrity of the radio resources. The BSC element can control one or more base transceiver stations 5-8 in call set-up functions, signalling, use of radio channels, and various maintenance tasks. The third generation network providing mobile access to a number of core networks of both mobile and fixed origin is the radio access network RAN 5-10.

In unicast communication, the same load is transmitted to every recipient UE1, UE2 and UE5 of the group. If too many recipients are in the same resource, the group communication traffic exceeds the threshold level and the group communication element cannot serve the group and/or the quality of communication decreases. According to the invention and its embodiments, this causes new independent resources to be allocated and provided for at least one user terminal, e.g. by transferring 1-20 the mobile terminal UE5 from the cell 1-2 to the cell 1-6.

When resources for group communication are optimized, various network elements need to know which user equipment, terminals or communicators belong to the same group and the same group communication in order to treat them accordingly. This is important e.g. for handovers to enable the terminals or communicators to be distributed over independent resources and to avoid congestion as well as possible. Without knowing which mobiles belong to the same group the resource-controlling unit would be unable to distribute them over independent units. However, in prior art, the radio access (BSC, RNC) is unaware of, which mobiles belong together, i.e. form a communication group. Group calls, for instance, generate very bursty traffic, which requires a lot of capacity for even short period of times, especially when the group members are concentrated in one resource unit.

Group information can be obtained and/or maintained and/or transmitted in and/or via various network elements either in a centralized manner or in a distributed manner. According to the invention and its embodiments an indicator can be created in the radio access network to identify, which mobile stations belong to the same group communication. The group communication indicator can be generated inside the resource controlling unit e.g. by recognizing the same data packets and/or transmission patterns, or it can be added as a new information element to standardized interfaces explicitly labelling group members.

The indication can be formed e.g. in radio access network, like in RNC or it can be in group server transferring through the signal and BSC can use this information in group server.

In other words communications terminal (UE1 . . . UE5) that belongs to the communications group (GR1) can be detected at least partly by recognizing and comparing data packets to be transmitted to communications terminals (UE1 . . . UE5) and/or by recognizing and comparing transmission patterns of transmissions to communications terminals (UE1 . . . UE5). Additionally, an indicator, a group call indicator can be assigned to the communications terminal (UE1 . . . UE5) in response to detecting a communications terminal (UE1 . . . UE5) belonging to the communications group (GR1) and detecting thereafter, on the basis of the indicator, the communications terminal (UE1 . . . UE5) that belongs to the communications group (GR1).

In a still further embodiment an indicator is assigned to communications terminals (UE1 . . . UE5) that belong to a same communications group; and, on the basis of the indicator, the communications terminal (UE1 . . . UE5) are detected that belongs to the communications group (GR1).

The group call indicator can be used e.g. in signals of a communications system supporting group communication and comprising an access network element. The indicator can indicate to the access network element communications terminals (UE1 . . . UE5) that belong to the communications group (GR1).

The communications group can also be e.g. an ad hoc group, which users can establish themselves for their own use without the need to contact the operator or to use a group management system. In a push to talk over cellular (PoC) system, the ad hoc group can be created when the owner attaches to it, and the group is deleted when the last user or owner detaches from it.

There can be a transmission from a first sender concerning information, who belongs to the group, and the server can then deliver data to the participants of the group.

When a group call indicator is generated by detecting characteristic transmission patterns, at least one of the following criteria may be used for detecting members belonging to the same group: same QoS parameter(s), same duplex usage (e.g. while listening PoC users only DL resources are used), or synchronous call/data arrival. In other words, the radio network concludes that mobile stations receiving at the same time user data with the same bitrate (either guaranteed bitrate or effective bitrate), traffic class, traffic handling priority and/or same duplex most likely belong to the same group. A possible refinement to increase correctness of detection is to trace the above parameter(s) over time and conclude from the call history. It must be noted that it is desirable to exchange the group membership between controlling resources, e.g. between a first BSC element and a second BSC element, to avoid handing over a group member to an already existing large group. The mapping of group members in different units can be carried out by a call and/or data arrival time and a QoS profile.

In other words an indication of a group (GR1) membership can be send from an application server to at least one other network element and the communication group (GR1) can be detected on the basis on said indication.

Another possibility is to standardize (e.g. in 3 GPP, 3rd Generation Partnership Project) explicitly the indication of group membership from the application server to the other relevant network elements, e.g. from the PoC server to the BSC element and/or to the RNC element.

The radio network controller may receive group information over a Gb interface and may then use this information for handovers to distribute group members over separate cells and to reduce congestion. A, Iu and Iur interfaces can also be used. It is to be noted that for MBMS (multicasting) services the radio network controller is informed by the SGSN about terminals belonging to the group of receivers (UE Linking procedure). One object of the present invention and its embodiments is to introduce such indicators also for other services.

The identification of group members may be more important in an (E)GPRS ((Enhanced) GPRS) system than in a WCDMA system, because in (E)GPRS the group capacity per cell can be significantly smaller than that in the WCDMA (Wideband Code Division Multiple Access) system.

The invention and its embodiments provide many advantages. For example, resources for group communication can be more efficiently used and PoC capacity can be increased. This is important for GPRS systems, where group capacity per cell can be smaller than that in WCDMA systems.

Furthermore, the invention and its embodiments overcome the problems of current handover and overload control methods, which do not recognize group calls as such but handle each communication station separately. In the case of congestion, this means that the last incoming call can be blocked. This can now be prevented. Furthermore, e.g. the last incoming call can now be prevented from experiencing significant delays or being moved to another cell.

Since experiencing delays may deteriorate service quality, e.g. in online gaming, and a handover to another cell is not always possible for a mobile station arriving last because of a lack of good neighbours, the invention and its embodiments provide better service quality and also enable the resources to be more efficiently used.

It will be obvious to a person skilled in the art that as technology advances, the inventive concept can be implemented in various ways. The invention and its embodiments are not limited to the examples described above but may vary within the scope of the claims.

1. A method for providing a handover in a communications system supporting group communication, the method comprising:
detecting communications terminals that belong to a communications group;
monitoring a load of the communications group in a first resource; and
performing, to at least one of the communications terminals of the communications group, a handover from the first resource to a second resource, when the load exceeds a predetermined load level in the first resource.

2. A method according to claim 1, comprising detecting a communications terminal that belongs to the communications group at least partly by recognizing and comparing data packets to be transmitted to the communications terminals.

3. A method according to claim 1, comprising detecting a communications terminal that belongs to the communications group at least partly by recognizing and comparing transmission patterns of transmissions to the communications terminals.

4. A method according to claim 3, wherein the transmission patterns comprise at least one of the following parameters: bitrate, traffic class, traffic handling priority, QoS parameter, duplex usage, and synchronous call/data arrival.

5. A method according to claim 4, comprising tracing at least one of the parameters over time.

6. A method according to claim 2, comprising assigning an indicator to the communications terminal in response to detecting a communications terminal belonging to the communications group and detecting thereafter, on a basis of the indicator, the communications terminal that belongs to the communications group.

7. A method according to claim 1, comprising:
assigning an indicator to the communications terminals that belong to a same communications group; and
detecting, on a basis of the indicator, a communications terminal that belongs to the communications group.

8. A method according to claim 1, comprising checking, before performing said handover to the communications terminals from the first resource to the second resource, whether the second resource has capacity to serve the communications terminals.

9. A method according to claim 1, comprising calculating a number of group members in different resources and managing the handover at least partly based on said calculation.

10. A method according to claim 1, comprising selecting the communications terminals to which the group communication handover from the first resource to the second resource is performed on a basis of at least one of time, priority, billing information, and an order in which the communications terminals enter the first resource.

11. A method according to claim 1, comprising sending, from an application server to at least one other network element, an indication of a group membership and detecting the communications group on a basis of said indication.

12. A network element for providing a handover in a communications system supporting group communication, wherein the element comprises:
an admission control block configured to
detect communications terminals that belong to a communications group;
monitor a group communication load; and
indicate a need for handover for at least one communications terminal of the communications group from a first resource to a second resource in response to the group communication load exceeding a predetermined threshold level set for the group communication load.

13. A network element according to claim 12, wherein the element is configured to determine an actual allocation of resources in response to a request for a new resource during at least one of a bearer setup, a bearer re-negotiation, and a handover.

14. A network element according to claim 13, wherein the determination is at least partly based on at least one of available resources, a state of currently allocated resources, a system load, and capabilities of the at least one communications terminal.

15. A network element according to claim 12, wherein the network element is a radio access network element.

16. A network element for providing a handover in a communications system supporting group communication, wherein the element comprises a handover control block having memory for at least one parameter relating to group communication load, the handover control block being configured, at least partly based on said at least one parameter, to perform the handover for at least one recipient of the group from a first resource to a second resource in response to the group communication load exceeding a predetermined threshold level set for the group communication load.

17. A group call indicator usable in signals of a communications system supporting group communication, said communications system comprising an access network element, wherein the indicator indicates to the access network element communications terminals that belong to a communications group.
